(19) United States
(12) Patent Application Publication
(10) Pub. No.: US 2017/0107681 A1
(43) Pub. Date: Apr. 20, 2017

(54) A HAMMERING DEVICE

(71) Applicant: MOVAX OY, Hämeenlinna (FI)

(72) Inventors: Pentti KUIVAMÄKI, Hyvinkää (FI); Mikko LINDEMAN, Hämeenlinna (FI)

(73) Assignee: MOVAX OY, Hämeenlinna (FI)

(21) Appl. No.: 15/127,146

(22) PCT Filed: Mar. 19, 2015
(86) PCT No.: PCT/FI2015/000010

§ 371 Date: Sep. 19, 2016

(30) Foreign Application Priority Data
Mar. 19, 2014 (FI) 20140081

(51) Int. Cl. E02D 7/18; B25D 9/12

(52) U.S. Cl. CPC E02D 7/18; B25D 9/12

(57) ABSTRACT

A hammering device which can be coupled to a working machine, said device comprising a first frame, said frame having means for attaching to the working machine and to the frame coupled at a distance from each other locating series suspensions means, via which as a frame for vibrators working second frame can be attached to the first frame, wherein said second frame comprises vibrators and gripping jaws for gripping to an object, wherein the gripping jaws locate on turning jaw bars wherein said bars can be moved by means of hydraulic cylinder and that the first frame is like a forking frame of U-form coupled to the attachment means, which has suspension means on the inner surfaces of both forks, via which suspension means the second frame has been attached to the first frame. The second frame is directed both backwards and downwards along the portion so that the articulation points of the turning jaw bars fitted in the second frame can be located in such a position that the gripping jaws which are belonging to the ends of the jaw bars which have been attached to said articulating points locate centric in relation to said vibrators and suspension means.

### PRIORITY

This application is a U.S. national application of PCT-application PCT/FI2015/000010 filed on Mar. 19, 2015 and claiming priority of the Finnish national application number FI 20140081 filed on Mar. 19, 2014, the contents of all of which are incorporated herein by reference.

### FIELD OF THE INVENTION

The invention relates to a hammering device which can be coupled to a working machine, said device comprising a first frame, said frame having means for attaching to the working machine and to the frame coupled at a distance from each other locating series suspension means, via which as a frame for vibrators working second frame can be attached to the first frame, wherein said second frame comprises vibrators and gripping jaws for gripping to an object, wherein the gripping jaws locate on turning jaw bars wherein said bars can be moved by means of hydraulic cylinder and that the first frame is like a forking frame of U-form coupled to the attachment means, which has suspension means on the inner surfaces of both forks, via which suspension means the second frame has been attached to the first frame.

### BACKGROUND OF THE INVENTION

A hammering device according to the above preamble is previously known from published Finnish applications FI-20100161 and FI-20120026 where the object to be hammered can be gripped with side grip and hammering force is transferred to the object via jaw bars of the gripping jaws. In these solutions vibrator device has been placed essentially deviating from the vertical line which goes via longish object to be hammered and which would be the most effective hammering line. This deviation causes loads to the construction of the hammering device and also reduces the hammering effect.

### SUMMARY OF THE INVENTION

In order to remove these disadvantages, a new hammering device has been developed by means of which device the above described disadvantages and drawbacks can be avoided. It is characteristic of the invention that the second frame is directed both backwards and downwards along the portion so that the articulation points of the turning jaw bars fitted in the second frame can be located in such a position that the gripping jaws which are belonging to the ends of the jaw bars which have been attached to said articulating points locate centric in relation to said vibrators and suspension means.

The advantage of the invention is the fact that also in the hammering by means of side grip centric hammerings can be obtained when there are two vibrator devices, one device in both sides of the object to be hammered so, that their common hammering line goes to the object via in the grip situation working gripping organs. An advantage is further that also suspended attachment organs coupling the vibrator devices to the frame of the hammering device are placed centric in both sides of the gripping jaws which are transferring the hammerings to the object. In this case in the side grip gripping no inclined directed forces are produced which forces will try to turn gripping jaws when being in the grip during the hammering. The hammering also are effecting with full power to the object. Further by means of the working machine the hammering device can be easily kept in the intended hammering line when there are not existing inclined directed forces which turn the object during hammering.

### BRIEF DESCRIPTION OF THE DRAWINGS

In the following the invention is described more detailed by referring to the attached drawings in which

FIG. 1 shows a hammering device according to the invention seen from the side.

FIG. 2 shows a hammering device seen from the side.

FIG. 3 shows a hammering device as the first frame removed.

FIG. 4 shows a hammering device according to the FIG. 3 seen from below.

### DETAILED DESCRIPTION OF THE INVENTION

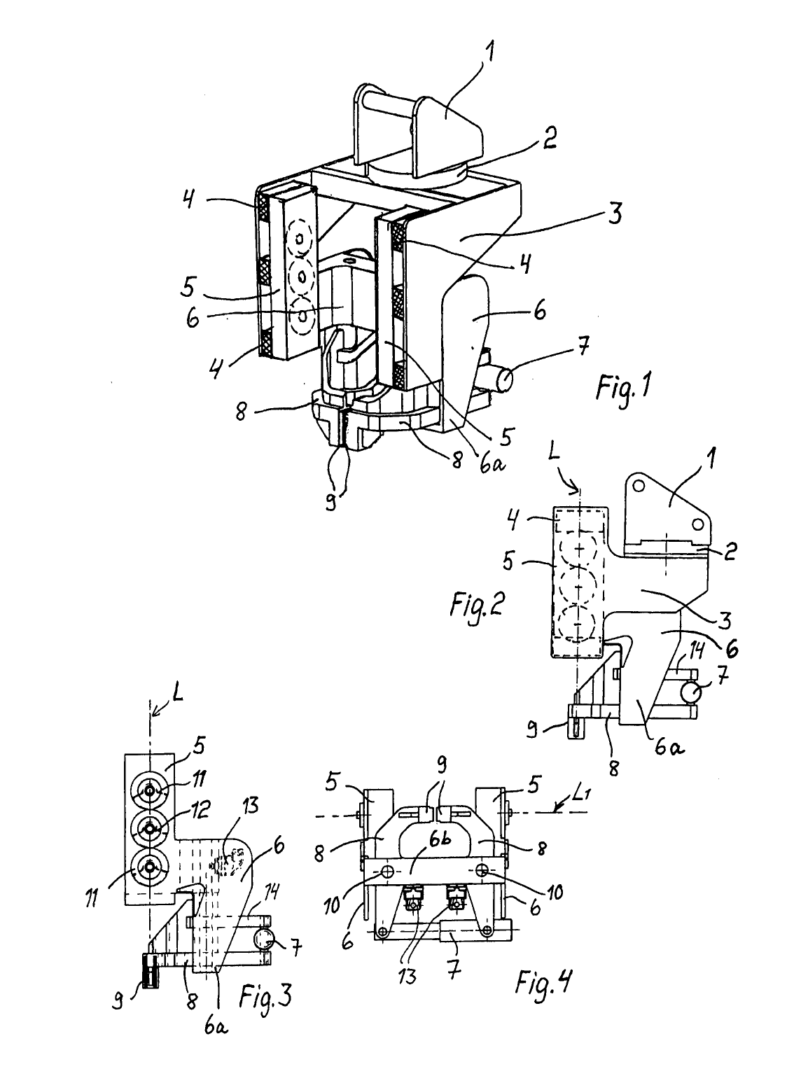

In FIG. 1 there is shown a hammering device which is attached to a working machine by means of an attachment means 1. Between the hammering device and attachment means a rotation device 2 has been in this case still fitted for rotating the hammering device round its vertical axis. Below the rotation device 2 there is first frame 3 of the hammering device, which is forking to two forks as U-form so, that both forks are ending to series of suspension organs, which are formed of several suspension organs 4. Two vibrators 5 belonging to the second frame 6 have been attached to the suspension organs 4. The second frame 6 hangs by means of the vibrators 5 from the first frame 3. The second frame 6 extends both rearwards and downwards to a portion 6a and there has been by means of a cylinder 7 moved gripping jaws 9 attached on the lower level in relation to vibrators 5 said jaws having articulation points 10 (FIG. 4). The gripping jaws 9 locate in the ends of the jaw bars 8 for gripping to the hammered object.

FIG. 2 shows, how U-formed first frame 3 locates outer with its forking sides and the upper part of the second frame 6 locates inside the forking sides. In FIG. 2 there is shown, how the suspension organs 4, vibrators 5 and the gripping jaws 9 all locate in the same line L. Vibrators 5 and series of the suspension organs locate, however, in both sides of the line L, not direct in the line L, but the impact lines of both they together being one common line locates in the line L, because they locate centric in relation to the line L. The hammering force is so transferred also when hammered by side grip in the direction of the object to the object, not causing harmful side forces or not turning effort to the jaw bars 8 in the grip.

FIG. 3 shows the device as the first frame 3 removed, wherein the vibrator alone is presented. In this embodiment both vibrators have three rotatable masses 11, 12 one on the other. The mass 12 in the middle can be twice compared with the masses 11, wherein the side forces have been compensated. In the vertical direction a maximum vibrator force is achieved.

Masses 11, 12 are rotated by a hydraulic motor 13. Above the jaw bar 8 there is another bar 14, in order a pure turning force is obtained for the articulation points 10.

FIG. 4 shows the vibrator seen from below. Also here a line L1 can be found, which line goes via the gripping organs and the vibrators 5. A portion 6b joins the lower parts 6a of the second frame 6.

In one embodiment both vibrators have only two eccentric masses. In this case they are placed in vibrator housing side by side in horizontal direction and rotated in different directions. The eccentric masses are mounted so that the line L goes between them i.e. via the point of their cog contact. This solution increases dimensions of the vibrator housing causing increased lengths for the forks in the U-form. If this is allowed this solution is also usable.

In another embodiment both vibrator housings have only one eccentric mass. In this case the rotation axis of both eccentric masses has same direction than the fork of the first frame 3 has and the eccentric masses are rotated in the opposite directions. This solution causes increased distance between the forks in the frame 3. And this causes increased bread for the whole hammering device.

The object can be hammered both from top and by means of the side grip.

1. A hammering device which can be coupled to a working machine, comprising a first frame having attachment means for attaching to the working machine and to the frame coupled at a distance from each other locating series suspensions means, via which as a frame for vibrators working second frame can be attached to the first frame, wherein said second frame comprises vibrators and gripping jaws for gripping to an object, wherein the gripping jaws locate on turning jaw bars wherein said bars can be moved by means of hydraulic cylinder and that the first frame is like a forking frame of U-form coupled to the attachment means, which has suspension means on inner surfaces of both forks, via which suspension means the second frame has been attached to the first frame,
wherein the second frame extends both backwards and downwards so that articulation points of the turning jaw bars fitted in the second frame can be located in such a position that the gripping jaws which are belonging to the ends of the jaw bars which have been attached to said articulating points locate centric in relation to said vibrators and suspension means such that suspension means, vibrators and the gripping jaws all locate on a same line, wherein the vibrators and the suspension means locate on both sides of the line.

2. A hammering device according to the claim 1, wherein the vibrators are located on both sides of gripping lines of gripping means so that their common middle line of vertical forces goes via gripping line of the gripping means.

3. A hammering device according to the claim 1, wherein both vibrators have at least one rotatable eccentric mass.

4. A hammering device according to the claim 1, wherein both vibrators have at least three or more rotatable eccentric masses in same vertical line.

5. A hammering device according to the claim 1, wherein hammering force is fitted to transfer from vibrators to the jaw bars via the articulation points of the jaw bars.

6. A hammering device according to the claim 5, wherein the articulation points are located in the second frame on a lower height level than the vibrators.

7. A hammering device according to the claim 1, wherein the hammering device can be fitted to hammer the object from top and to grip the object via side grip and to hammer by means of side grip.

8. A hammering device according to the claim 1, wherein the vibrators are placed as first equipment beside both series of the suspension means wherein the second frame is fitted to extend from both vibrators to the attachment points of the jaw bars.

9. A hammering device according to the claim 1, wherein both vibrators comprise only two eccentric masses, the eccentric masses being mounted so that the line goes between them via the point of their cog contact.

10. A hammering device according to the claim 1, wherein the vibrator comprises vibrator housings, and both vibrator housings have only one eccentric mass.
